(19) United States
(12) Patent Application Publication
(10) Pub. No.: US 2025/0343816 A1
(43) Pub. Date: Nov. 6, 2025

(54) ESTIMATING THE RISK OF MEMBERSHIP INFERENCE ATTACKS ON MACHINE LEARNING MODELS

(71) Applicant: Microsoft Technology Licensing, LLC, Redmond, WA (US)

(72) Inventors: Shruti Shrikant TOPLE, Cambridge (GB); Boris Alexander KÖPF, Cambridge (GB); Santiago Jose ZANELLA BEGUELIN, Cambridge, Cambridgeshire, England (GB); Daniel JONES, Nea Makri (GR); Lukas WUTSCHITZ, London, England (GB); Victor Jonas RÜHLE, Cambridge, England (GB); Andrew James PAVERD, Cambridge, England (GB); Ahmed Mohamed Gamal SALEM, Saarbrucken, Saarland (DE); Mohammad NASERI, Manchester, England (GB)

(21) Appl. No.: 18/855,582

(22) PCT Filed: Apr. 7, 2023
(86) PCT No.: PCT/US2023/017950

§ 371 Date: Oct. 9, 2024

(30) Foreign Application Priority Data
May 13, 2022 (LU) LU502086

(51) Int. Cl. H04L 9/40; G06V 10/82; G06V 10/94; G06V 10/96

(52) U.S. Cl. CPC H04L 63/1433; G06V 10/82; G06V 10/95; G06V 10/96

(57) ABSTRACT

In various examples there is a method of empirically measuring a level of security’ of a training pipeline. The training pipeline is configured to train machine learning models using confidential training data. The method comprises storing a representation of a joint distribution of false positive rate and false negative rate of membership inference attacks on a plurality of machine learning models trained using the training pipeline. The method uses the representation to compute a posterior distribution of the level of security’ from observations of the membership inference attack on the plurality’ of machine learning models trained using the training pipelines. A confidence interval of the level of security is computed from the posterior distribution and the confidence interval is stored.

### CLAIM OF PRIORITY

This application claims the benefit of priority to Luxembourg Patent Application No. LU502086, filed May 13, 2022 which application is incorporated herein by reference in its entirety.

### BACKGROUND

Machine learning is widely used in a huge range of industries to enable automation of tasks such as control of self-driving vehicles, object recognition, manufacturing plant control, radiography, passport gate control, agricultural fertilizer use and more. Generally speaking, machine learning involves training a model using a large quantity of training examples in such a way that the model represents generalized information about the training examples. The trained model is used to make predictions about new examples it receives, where the new examples were not in the training examples. Since the model has generalized information about the original training examples, it is able to make accurate predictions about the new example.

Since machine learning models are often deployed in safety critical systems such as self-driving vehicles, radiography and others, security is extremely important. Often training data used to train machine learning models needs to be kept secure since the training data itself is confidential. Malicious parties with access to the training data examples gain knowledge and are also able to exploit that to potentially attack or tamper with the machine learning deployment. In some cases this can include obtaining parameters of the machine learning model itself.

The embodiments described below are not limited to implementations which solve any or all of the disadvantages of known machine learning systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a computer-implemented method of empirically measuring a level of security of a training pipeline. The training pipeline is configured to train machine learning models using confidential training data. The method comprises storing a representation of a joint distribution of false positive rate and false negative rate of membership inference attacks on a plurality of machine learning models trained using the training pipeline. The method uses the representation to compute a posterior distribution of the level of security from observations of the membership inference attack on the plurality of machine learning models trained using the training pipeline. A confidence interval of the level of security is computed from the posterior distribution and the confidence interval is stored.

In various examples the confidence interval is compared with a threshold and in response to the confidence interval being below the threshold the method comprises deploying machine learning models trained using the training pipeline at unprotected devices. In contrast, where the confidence interval is above the threshold the method comprises deploying machine learned models trained using the training pipeline at protected devices and controlling access to the machine learned models using one or more of: authentication (such as multi factor authentication), authorization, encryption.

In various examples the training pipeline is configured to train convolutional neural networks to carry out object recognition tasks and the training data set comprises images.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a security measurement component in communication with a training pipeline and training data;

FIG. 2 is a flow diagram of a method performed by the security measurement component of FIG. 1;

FIG. 3 is a flow diagram of more detail of part of FIG. 2;

FIG. 4 is a flow diagram of another example of more detail of part of FIG. 2;

FIG. 5 illustrates an exemplary computing-based device in which embodiments of a security measurement component are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As explained above, machine learning is widely used in a large range of industries and there is a consequent need for machine learning security. Machine learning models are deployed on a range of devices including end user devices such as smart phones, smart watches, wearable computers, self-driving vehicles, hospital equipment, agricultural machinery, manufacturing machinery and more. Machine learning models are also deployed as cloud services. Thus there is also a wide range of levels of security available according to where and how machine learning models are deployed. A machine learning model deployed at a consumer device such as a smart phone may be less secure, for example, than one deployed in a control room of a nuclear reactor.

It is known that malicious parties are able to carry out attacks on machine learning models in order to gain knowledge about training data used to train those models and/or to obtain the machine learning model itself. Attacks may involve accessing the models themselves where those are deployed in insecure locations such as outside a trusted execution environment. Attacks may involve obtaining training data used to train a model such as by observing behavior of the model and using the observations to infer training data examples which were used to train the model. An inference that a given data example (also referred to as a sample) was part of the training data set may constitute a data privacy breach. For example, knowing that a certain patient's clinical data record was used as a training data example for a model related to a certain disease would appear to suggest that the patient has that disease. Further, once training data used in training the model is obtained, it is possible for malicious parties to also carry out attacks to gain the values of parameters of the machine learning model itself.

One approach to improving security is therefore to carefully select where and how a machine learning model is deployed and/or to control which parties are able to observe behavior of the model. Deploying machine learning models within trusted execution environments is one option to enable control of which parties are able to access a machine learning model. In order to control which parties are able to observe behavior of the model, known communication technologies for enforcing authentication and authorization are usable together with encryption. Such approaches for enhancing security are computationally expensive and add complexity and/or latency.

Algorithms for training machine learning models using differential privacy are also available in order to reduce the risk of malicious parties inferring training data. Since the risk of inferring training data is reduced, the risk of using inferred training data to obtain the machine learning model itself is also reduced.

Generally speaking, differentially private algorithms for training machine learning models inject noise into training data used to train a machine learning model. Such algorithms seek to carefully control the amount of injected noise since injecting too much noise reduces the performance of the machine learning model whereas injecting too little makes it easier for malicious parties to infer training data examples. However, the inventors have recognized that even though it is possible to control how much noise is injected, the amount of security obtained as a result is difficult to determine since there is no principled relationship which can be used. Generally speaking, even when a training algorithm is known, the level of practical security for a given threat of a resulting machine learning model is uncertain.

The term “training pipeline” is used herein to refer to a deployment of a specified training algorithm for training a machine learning model. The deployment may be distributed over a plurality of computation nodes in a communications network, such as a data centre or other communications network. A given training pipeline is usable to train many different machine learning models using the same or different training data. A non-exhaustive list of examples of suitable training algorithms is: backpropagation with stochastic gradient descent SGD, backpropagation with differentially private SGD.

The inventors have developed a way of empirically measuring a level of security of a training pipeline which is precise and efficient. The level of security is denoted by the symbol \hat{ε} and is a positive real value referred to as empirical epsilon. Empirical epsilon is a statistical estimate of the “differential-privacy parameter” or “privacy budget” ε, which is a formal metric of the privacy loss resulting from a differential change in data (e.g. the addition or removal of one data example). Lower values of ε, and thus of empirical epsilon, indicate higher security. In various examples, the measurement process produces a range referred to as a confidence interval and is a range of values of empirical epsilon \hat{ε} within which the level of security of the training pipeline exists Machine learning models trained with a training pipeline that has poor security (i.e. high empirical epsilon) are to be deployed with high security, such as using a trusted execution environment and secure communications protocols with authentication and authorization. Machine learning models trained with a training pipeline that has high security (i.e. low empirical epsilon) are deployable without using a trusted execution environment and/or secure communications protocols.

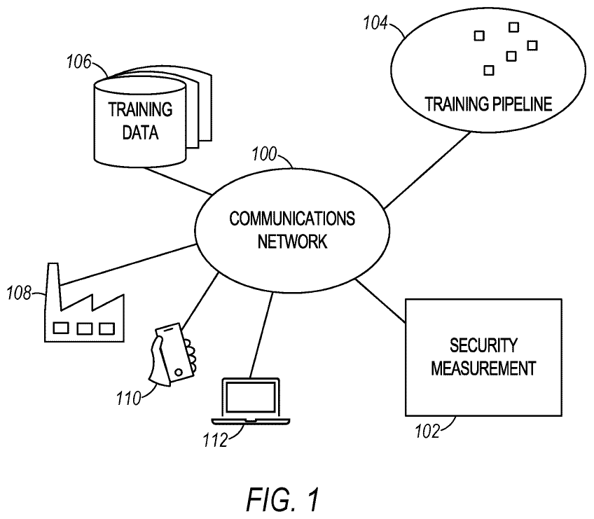

FIG. 1 is a schematic diagram of a security measurement component 102 which is computer implemented and connected to communications network 100. The security measurement component has functionality to measure a level of security (referred to as empirical epsilon) of a training pipeline 104 connected to the communications network 100. The training pipeline is a deployment of a distributed machine learning algorithm such as in a data centre, cluster of compute nodes or other platform. The training pipeline 104 has access to training data 106 via the communications network. The training data is confidential and is stored in one or more secure stores.

The security measurement component 102 is able to trigger deployment of machine learning models which have been trained using the training pipeline 104 onto computing resources such as smart phones 110, laptop computers 112, manufacturing plant control systems 108, data centres, or other computing resources. The security measurement component 102 is able to take into account the measured level of security when determining which resources to use for deploying a machine learning model trained using the training pipeline. To do this, the security measurement component 102 uses information about security available at the various computing resources.

The security measurement component 102 is able to tune hyperparameters of the training pipeline 104 according to the measured level of security.

The security measurement component of the disclosure operates in an unconventional manner to achieve precise, efficient measurement of a level of security of the training pipeline. The security management component uses a representation of a joint distribution of a false positive rate and a false negative rate of a membership inference attack on machine learning models trained using the pipeline.

A membership inference attack occurs when an adversary, given the training pipeline, the number of training examples in the training data set used by the training pipeline, and a distribution over possible training examples (i.e. the distribution from which the training data set used by the training pipeline was drawn), attempts to determine whether an example from the distribution belongs to (in other words, is a member of) the training data set used by the training pipeline. The performance of the adversary on the training pipeline (i.e on machine learned models trained using the training pipeline), which may be quantified in terms of false positive and false negative rates, is an indicator of the level of security provided by the training pipeline. Accordingly, the false positive and false negative rates are used by the security measurement component to compute a confidence interval for empirical epsilon, as detailed below.

The security measurement component is implemented using software in some cases. Alternatively, or in addition, the functionality of the security measurement component described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

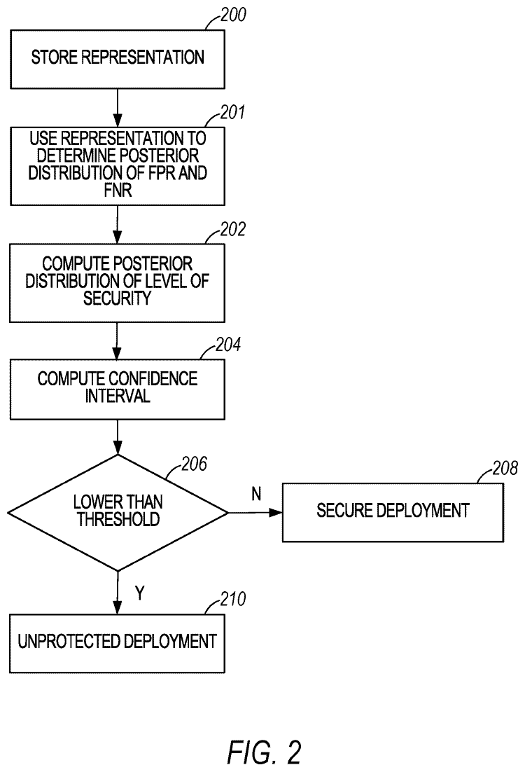

FIG. 2 is a flow diagram of a method performed by the security measurement component of FIG. 1. The method is for empirically measuring a level of security E of a training pipeline such as training pipeline 104 of FIG. 1, and then making decisions about the deployment of the training pipeline based on the measured level of security. The level of security is a positive real value, where lower values of the value indicate higher security. The method comprises storing 200 a representation of a joint distribution of false positive rate and false negative rate of a membership inference attack on machine learning models trained using the pipeline. More details about the representation are given later.

The representation of the joint distribution of false positive rate and false negative rate of a membership inference attack is used to compute a posterior distribution of the level of security from observations of the training pipeline during membership inference attacks. The posterior distribution of the level of security may be computed 202 from a posterior joint distribution of the false positive and false negative rates as determined 201 from the representation using counts of false positives and false negatives observed during the membership inference attacks. A confidence interval of the level of security is computed 204 from the posterior distribution of the security level. In some cases the confidence interval is stored and is a range of possible values of the measured security level.

In some examples, the security measurement component 102 checks 206 whether the confidence interval is lower than a threshold. If not, the security measurement component 102 triggers secure deployment 208 of a machine learning model trained using the training pipeline. Secure deployment means deploying the machine learning model in a trusted execution environment and/or controlling access to the machine learning model using authentication and authorization as well as encryption.

If the check at operation 206 is successful, the security measurement component 102 triggers unprotected deployment 210 of a machine learning model trained using the training pipeline. Unprotected deployment means deployment outside a trusted execution environment and/or without controlling access to the machine learning model using authentication and authorization as well as encryption.

In some cases FIG. 2 is modified so that the outcome of check 206 results in the process of tuning hyperparameters of the training pipeline. The hyperparameters comprise one or more of: differential privacy parameters, number of training steps, batch size, learning rate in stochastic gradient descent. Differential privacy parameters include the privacy budget c and the parameter δ. The privacy budget a can take any positive real value and the parameter δ is a small value that is usually inversely proportional to the size of the training data set. As explained above, lower values of s, and thus of empirical epsilon, indicate higher security. Thus, the hyperparameter ε is tuned by decreasing its value in order to increase the level of security. Generally speaking, as the number of training steps increases the level of security decreases (i.e. the value of ε increases with increase in training steps). In general, any hyperparameter may have an effect on the empirical epsilon.

In examples, the representation of joint distribution is a Bayesian model of the false positive rate and the false negative rate. Using a Bayesian model is found to give precise, accurate measurements of the level of security, empirical epsilon. Using a Bayesian model, it is possible to update belief about a distribution of the false positive rate (or false negative rate) after obtaining new data about the outcomes of membership inference attacks. Bayesian model is a probabilistic model comprising a prior distribution, a posterior distribution and a rule for computing the posterior distribution in light of the prior distribution and observations.

In some cases the joint distribution is determined with a Bayesian model where the prior distribution and/or the posterior distribution is a Dirichlet distribution. With a Bayesian model, assume the simple case of independence between the false positive rates and the false negative rates and compute the joint distribution. In some other cases, the joint distribution is computed based on a more complex model without considering any assumptions such as using a Dirichlet distribution.

Alternative approaches using two-sided Clopper-Pearson confidence intervals for false positive and false negative rates of attacks are found to be inferior. Clopper-Pearson intervals notoriously underestimate coverage and necessitate an unfeasible number of samples to draw conclusions with high confidence. Intervals for empirical epsilon derived from two-sided Clopper-Pearson intervals are so wide that they often include 0 and have an upper limit higher than the provable upper bound for differentially private (DP) models. In contrast, the Bayesian approach described herein enables to directly obtain confidence intervals from the posterior distribution of \tilde{ε}.

Experiments compare equal-tailed credible intervals for \tilde{ε} obtained using the Bayesian approach of the present disclosure to confidence intervals for \tilde{ε} derived from two-sided Clopper-Pearson and Jeffreys intervals. The results show a reduction of 40% in the interval length for the same number of samples when using the technology of the present disclosure. In addition, the computational cost is a fraction of that used by the alternative approaches.

In some cases the representation of the joint distribution comprises, for each of the false positive rate and the false negative rate, a prior distribution such as a Beta distribution having parameters A and B, a count of observations of false positives (or false negatives) k drawn from a Binomial distribution with parameters N (denoting the number of membership interference attacks observed) and a prior probability p drawn from the prior distribution, and a posterior distribution such as a Beta distribution with parameters A+k (A plus the count) and B+N−k (B plus a number of membership inference attacks minus the count). The values of A and B sum to one in some but not all cases and are adjusted according to how the representation is to be biased towards either false positives or false negatives. This enables the representation to be tailored for particular machine learning tasks. The values of parameters A and B are set by an operator in some examples using a user interface.

In an example A and B are both one half and the representation is expressed using mathematical notation as follows, once for false positives and then a second time for false negatives:

$$p ∼ Beta ( 1 / 2 , 1 / 2 )$$

$$k \vert p ∼ Bin ( N , p )$$

$$p \vert k ∼ Beta ( 1 / 2 + k , 1 / 2 + N - k )$$

This is expressed in words for the case of false positives as: assume that the prior probability of a false positive is drawn from a Beta distribution with parameters one half and one half, and that a count of observations of false positives is drawn from a Binomial distribution with parameters N (denoting the number of membership interference attacks observed) and the prior probability p, then the posterior probability of a false positive given the count of observations of false positives k is drawn from a Beta distribution with parameters one half plus the count of observations of false positives, and one half plus a number of membership inference attacks minus the count of observations of false positives.

The parameters A and B are parameters of the prior of either the false positive or false negative rate. The parameters A and B represent how probable a priori are values for the false positive or false negative rate.

In the case of false negatives, the equations above are expressed in words as follows: assume the prior probability of a false negative is drawn from a Beta distribution with parameters one half and one half, and that a count of observations of false negatives is drawn from a Binomial distribution with parameters N (denoting the number of membership interference attacks observed) and the prior probability p, then the posterior probability of a false negative given the count of observations of false negatives k is drawn from a Beta distribution with parameters one half plus the count of observations of false negatives, and one half plus a number of membership inference attacks minus the count of observations of false negatives.

Using the equations mentioned above for both false positives and false negatives, it is possible to obtain a posterior distribution of the false positive rate and a posterior distribution of the false negative rate. This is done by counting false positives and false negatives and inserting the count values into the equations given above. The method carries out membership inference attacks (e.g. multiple runs of a membership inference experiment as defined below) on a plurality of machine learning models trained using the training pipeline and observes the false positive rate and false negative rate of the membership inference attack.

A product is then computed of the posterior distribution of the false positive rate and the posterior distribution of the false negative rate. That is, since the underlying populations of positive and negative instances are independent, it is possible to model these posteriors as independent, yielding the joint posterior distribution:

$${f}_{( FNR , FPR )} ( x , y ) := {f}_{( FNR \vert FN )} ( x ) {f}_{( FPR \vert FP )} ( y )$$

This is expressed in words as: the probability density of the posterior joint distribution over false negative rate x and false positive rate y is equal to the product of the posterior probability density over the false negative rate x given the observed count of false negatives and the posterior probability density over the false positive rate given the observed count of false positives, w.

Given the posterior probability density of the joint distribution over false negative rate and false positive rate, the security measurement component computes (see operation 204 of FIG. 2) a confidence interval within which the measured value of the security level exists.

To compute the confidence interval, the security measurement component computes a cumulative distribution of empirical epsilon as an integral of the probability density of the joint distribution over false negative rate and false positive rate over a region R. The region R is a region of possible pairs of values of the false positive rate and false negative rate, e.g. a “privacy region” associated with differential privacy parameters ε and δ for an (ε,δ)-differentially private training pipeline. The confidence interval has a lower bound which is the maximum value of epsilon for which the integral reaches its maximum value which is less than or equal to alpha divided by two. The confidence interval has an upper bound which is the minimum value of epsilon for which the integral reaches its minimum value which is greater than or equal to one minus half alpha. Alpha is a constant set by an operator. The confidence interval thus determined is referred to as a 100(1−alpha) % equal-tailed credible interval.

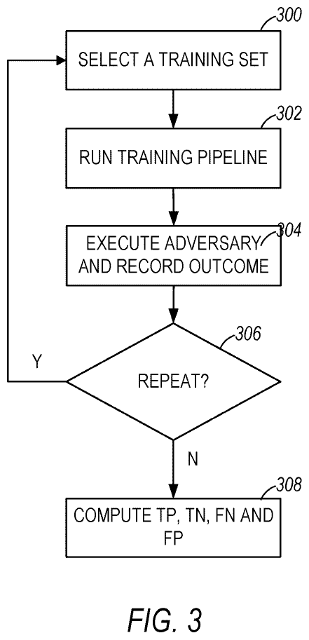

FIG. 3 is a flow diagram of more detail of operation 202 of FIG. 2. Operation 202 comprises using the representation to obtain a posterior distribution of the level of security \hat{ε}. As part of this operation, a training set is selected 300 from the training data (see 106 of FIG. 1) and the training pipeline is run 302 using the training set. An adversary is executed 304 against the resulting trained machine learning model to carry out a membership inference attack. The outcome of the membership inference attack is recorded.

Operations 300, 302 and 304 are then repeated so that another membership inference attack outcome is recorded, this time for a different machine learning model since the training set selected at operation 300 is different from the training set selected the first time operation 300 is carried out.

A check is made at decision point 306 whether to repeat again in order to obtain another membership inference attack outcome. The check involves seeing whether a specified number of membership inference attack outcomes have been recorded. If so, the method computes 308 a count of each of the possible outcomes of a membership inference attack which are: true positive, true negative, false positive, false negative. These counts are inserted into the representation to obtain the joint distribution of the false positive and false negative rates.

The membership inference attack used in FIG. 3 is any suitable membership inference attack which occurs when an adversary, given the training pipeline, a distribution over possible training examples, and the number of training examples in the training dataset used by the training pipeline, attempts to determine whether an example from the distribution belongs to the training data set.

In an example the membership inference attack is defined as follows and referred to as experiment one:

$$Input : T , D , n , A$$

$$S ∼ {D}^{n - 1} ; {z}_{0} , {z}_{1} ∼ {D}^{2}$$

$$b ∼ \{ 0 , 1 \}$$

$$θ ← T ( S ⋃ \{ {z}_{b} \} )$$

$$\tilde{b} ← A ( T , D , n , θ , {z}_{0} )$$

Assuming the following inputs: the training pipeline T, a distribution over the training data from which the training data set is drawn, a number of training data instances n in the training data set and an adversary A, the above operations can be expressed in words as: draw a training set S having n minus one training data instances from the distribution over the training data, and draw challenge points z₀ and z₁ both from the distribution over training data;
draw b from zero or one;
compute a trained machine learning model θ using the training pipeline T and the union of the training data set S and challenge point z_{b},
use the adversary to compute an estimate \tilde{b}, when the adversary is given the training pipeline T, the distribution over the training data, the number of examples n in the training data set, the trained machine learning model θ and the challenge point z₀.
\tilde{b} is compared with the drawn value of b in order to determine whether the membership inference attack outcome is true positive, true negative, false positive or false negative.

In another example the membership inference attack is defined as follows and referred to as experiment two:

$$Input : T , D , n , A$$

$$S , {z}_{0} , {z}_{1} ← {A}_{1} ( T , D , n )$$

$$b ∼ \{ 0 , 1 \}$$

$$θ ← T ( S ⋃ \{ {z}_{b} \} )$$

$$\tilde{b} ← {A}_{2} ( T , D , n , θ , S , {z}_{0} , {z}_{1} )$$

This gives the benefit that the adversary is more powerful because it has additional information (S and z1) to guess the value of b. Also the adversary can choose S, z0, z1 rather than these values being sampled.

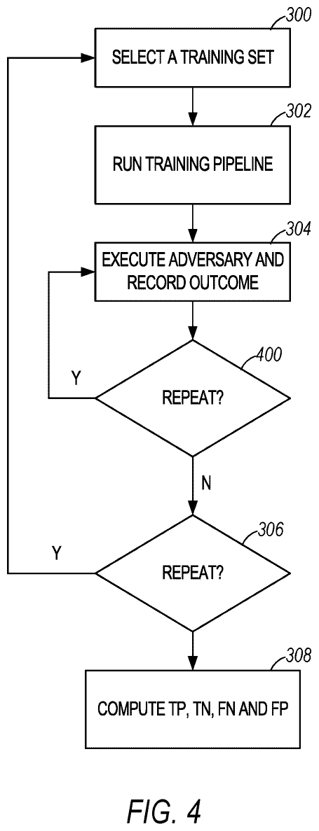

FIG. 4 is a flow diagram of another example of more detail of part of FIG. 2. In the example of FIG. 3 there is one membership inference attack outcome per trained machine learning model. In contrast, FIG. 4 uses more than one membership inference attack outcome per trained machine learning model. Thus FIG. 4 gives significant efficiency gains since training a machine learning model is very computationally expensive. The inventors have demonstrated by experiment that when the training pipeline uses DP, the method in FIG. 4 is a good approximation of the method of FIG. 3 (and more efficient). The method in FIG. 4 is applicable even when the training pipeline does not use DP.

FIG. 4 is a flow diagram of more detail of operation 202 of FIG. 2. Operation 202 comprises using the representation to obtain a posterior distribution of the level of security t. As part of this operation, a training set is selected 300 from the training data (see 106 of FIG. 1) and the training pipeline is run 302 using the training set. An adversary is executed 304 against the resulting trained machine learning model to carry out a membership inference attack. The outcome of the membership inference attack is recorded.

Operation 304 is repeated for a specified number of repetitions, with a check 400 being performed after each repetition.

Operations 300, 302 and 304 are then repeated so that another membership inference attack outcome is recorded, this time for a different machine learning model since the training set selected at operation 300 is different from the training set selected the first time operation 300 is carried out.

A check is made at decision point 306 whether to repeat again. The check involves seeing whether a specified number of membership inference attack outcomes have been recorded. If so, the method computes 308 a count of each of the possible outcomes of a membership inference attack which are: true positive, true negative, false positive, false negative.

The membership inference attack used in FIG. 4 is any suitable membership inference attack such as any of those described above.

Using empirical testing the inventors have found that the method of FIG. 4 gives accurate results where the training pipeline uses differential privacy, even though substantive efficiency gains are achieved compared with the method of FIG. 3. The method of FIG. 3 gives accurate results where the training pipeline uses differential privacy or does not use differential privacy.

In various examples the training pipeline is configured to train convolutional neural networks to carny out object recognition tasks and the training data set comprises images.

Detailed examples using mathematical notation are now given.

Let ε>0 and δ∈[0, 1].

A mechanism [symbol] : [symbol] → [symbol] is (ε, δ)-differentially private with respect to an adjacency relation:

$$R ⊆ \times if for any ( x , {x}^{′} ) ∈ R and any O ⊆ , Pr [ ( x ) ∈ O ] \leq {e}^{ε} Pr [ ( {x}^{′} ) ∈ O ] + δ$$

The mechanisms used are machine learning training pipelines of the form [symbol] : [symbol] ⁿ→→ that train a machine learning model θ∈Θ on a data set D of n examples from X. Refer to D as the training data set of θ, which under normal circumstances is composed of i.i.d. examples drawn from some underlying distribution D with supp(D)=X. Consider two training data sets as adjacent if one can be obtained from the other by substituting a single element.

A machine learning training pipeline [symbol] : [symbol] ⁿ→Θ is (ε, δ) differentially private if for any pair of adjacent training data sets D, D′ and any M⊆Θ,

$$Pr [ T ( D ) ∈ M ] \leq {e}^{ε} Pr [ T ( {D}^{′} ) ∈ M ] + δ$$

Consider a run of a mechanism [symbol] : [symbol] → [symbol] that outputs some [symbol] ∈ [symbol] when given one of two adjacent inputs x₀, x₁. Recast the differential privacy of [symbol] as a hypothesis test where the null hypothesis is that the input was x₀ and the alternative hypothesis is that it was x₁. The test rejects the null hypothesis when y is in a rejection region Y. A Type-I error (false positive) occurs when the null hypothesis is true but is rejected, with probability Pr [ [symbol] (x₀)∈Y]. A Type-II error (false negative) occurs when the null hypothesis is false but is not rejected, with probability Pr [ [symbol] (x₁)∈Y̅], where Y̅ denotes the complement of Y

A mechanism [symbol] : [symbol] → [symbol] is (∈, δ)-differentially private if and only if for all adjacent inputs x₀, x₁ and all Y⊆ [symbol] , the following conditions are met

$$Pr [ M ( {x}_{0} ) ∈ Y ] + {e}^{ε} Pr [ M ( {x}_{1} ) ∈ \overline{Y} ] \geq 1 - δ$$

$$Pr [ M ( {x}_{1} ) ∈ \overline{Y} ] + {e}^{ε} Pr [ M ( {x}_{0} ) ∈ \overline{\overline{Y}} ] \geq 1 - δ$$

A distinguisher that observes the output of an (ε, δ)-differentially private mechanism M and makes a guess as to which hypothesis is true implicitly defines a rejection region. The set of false positive and false negative rates achievable by distinguishers, or equivalently, the set of Type-I and Type-II errors for any rejection region must be included in the privacy region R (ε, δ), defined as follows:

$$R ( ε , δ ) := \{ ( x , y ) \vert x + {e}^{ε} y \geq 1 - δ ∧ y + {e}^{ε} x \geq 1 - δ ∧ y + {e}^{ε} x \leq {e}^{ε} + δ ∧ x + {e}^{ε} y \leq {e}^{ε} + δ \}$$

The privacy region grows with ε and covers the unit square as ε tends towards ∞.

The shape of [symbol] (ε, δ) is symmetric with respect to the FNR=1−FPR line because if a rejection region Y achieves (FNR, FPR), its complement Y̅ achieves (1−FNR, 1−FPR). It is also symmetric with respect to the FNR=FPR line because the adjacency relation is symmetric and so positive and negative instances are interchangeable.

Use Experiment 2 to bound the empirical privacy parameter \hat{ε} of a training pipeline for a fixed δ. An adversary with certain false positive and false negative rates (FNR, FPR) serves as a counterexample for the training pipeline being (ε, δ)-differentially private for every a such that (FNR, FPR)∉R(ε, δ). So, a lower bound for \hat{ε} is given by

$${\hat{ε}}_{-} = sup \{ ε ∈ {}^{+} \vert ( FNR , FPR ) ∉ R ( ε , δ ) \}$$

Assuming FPR, FNR≠0 and FPR, FNR≤1−δ, this is

$${\hat{ε}}_{-} = max \{ log \frac{1 - δ - FPR}{FNR} , log \frac{1 - δ - FNR}{FPR} \} \qquad ( 1 )$$

Since it is generally impossible to determine the value of FPR and FNR of an attack, use a Monte Carlo approach. Given samples {\tilde{b}, bᵢ} from runs of Experiment 2, compute sample estimates and intervals for FPR and FNR:

$$\overline{FPR} = \frac{{\sum }_{i = 1}^{m} [ {\tilde{b}}_{i} \neq {b}_{i} ∧ {b}_{i} = 0 ]}{{\sum }_{i = 1}^{m} [ {b}_{i} = 0 ]} ∈ [ {FPR}_{-} , {FPR}_{+} ]$$

$$\overline{FNR} = \frac{{\sum }_{i = 1}^{m} [ {\tilde{b}}_{i} \neq {b}_{i} ∧ {b}_{i} = 1 ]}{{\sum }_{i = 1}^{m} [ {b}_{i} = 1 ]} ∈ [ {FNR}_{-} , {FNR}_{+} ]$$

A lower bound for \hat{ε} is computed minimizing Eq. (1) over these confidence intervals (where the terms are well defined). Take the value at (FNR₊, FPR₊), but special care should be taken when either FPR_ or FNR_ is 0 as the minimum can occur at e.g., (FNR₊, 0). An upper bound \hat{ε}₊ can be computed analogously, but is arguably less interesting since it does not globally bound the privacy afforded by the training pipeline for other adversaries.

From the union bound, the significance of the confidence interval for \hat{ε} is double the significance of the confidence intervals for F̅P̅R̅ and F̅N̅R̅ used to derive it. For instance, when using 95% confidence intervals for F̅P̅R̅ and F̅N̅R̅, the derived confidence interval [\hat{ε}₋, \hat{ε}₊] has 90% confidence.

It is possible to greatly improve the quality of estimates using the joint posterior of (FNR, FPR) to derive a credible interval for \hat{ε} as now described. Given the probability density function ƒ_{(FNR,FPR)} of the joint posterior of (FNR, FPR), obtain the cumulative distribution of \hat{ε}.

Cumulative Distribution Function of \hat{ε}. Let δ∈[0, 1] and f (FNR,FPR) be the density function of the posterior joint distribution of (FNR, FPR) given observed counts of FN, TP, FP, TN (false negative, true positive, false positive, true negative) from Experiment 2. The value of the cumulative distribution function of \hat{ε} at ε is the integral of ƒ_{(FNR,FPR)} over the privacy region R(ε, δ);

$${F}_{ε} ( ϵ ) = [ FNR , FPR ) ∈ R ( ϵ , δ ) ] == \int {\int }_{R ( ε , δ )} {\int }_{( FNR , FPR )} ( x , y ) dxdy . \qquad ( 3 )$$

Equipped with F_{\hat{ε}} compute the 100(1−α)% equal-tailed credible interval [\hat{ε}₋, \hat{ε}₊]

$${\hat{ε}}_{-} = arg {max}_{ε} {F}_{\hat{ε}} ( ϵ ) \leq α / 2 \qquad ( 4 )$$

$${\hat{ε}}_{+} = arg {max}_{ε} {F}_{\hat{ε}} ( ϵ ) \geq 1 - α / 2 \qquad ( 5 )$$

The Bayesian model presented above gives the densities of the posteriors FNR|FN and FPR|FP. Since the underlying populations of positive and negative instances are independent, it is possible to represent these posteriors as independent, yielding

$${f}_{( FNR , FPR )} ( x , y ) := {f}_{( FNR \vert FN )} ( x ) {f}_{( FPR \vert FP )} ( y )$$

In an example, run 200 times Experiment 2 with an adversary A collecting samples {bᵢ, [symbol] }. Tally the guesses and get counts FN=35, TP=65, FP=25, TN=75. To derive a 90% confidence interval for \hat{ε}, compute the minimum and maximum of Eq. (1) over the two-sided Jeffreys intervals for FNR and FPR obtained from the tally, which yields [0.295, 1.489]. To derive instead a 90% credible interval, construct the cumulative distribution function of \hat{ε} by integrating the posterior of ƒ_{(FNR,FPR)} given the tally and solve Eqs. (4) and (5), which yields a narrower interval [0.522, 1.268].

In a worst-case regime, select challenge points with the largest train-test loss gap, which are identified by training several machine learning models on random in/out splits of the training and validation sets.

In an average-case regime, select them uniformly at random from the data set without replacement.

In experiments, rely on threshold attacks to determine membership. Specifically, use model-dependent thresholds which are chosen as an α-percentile of the distribution of the losses of each model's training set elements. Tune the α in a preprocessing step to yield the best (largest) estimate for empirical DP, based on challenge points that are chosen following the same regime (average or worst-case) as in the attack.

Experiments were performed on vision tasks using the well known data set CIFAR10 (Krizhevsky et al., 2009), consisting of 60,000 labeled images containing one of the ten object classes, with 6,000 images per class. It has a training set of 50,000 and a test set of 10,000 examples. Use a 4-layer convolutional neural network CNN with 974K parameters and Tanh activations functions with an average pooling and max pooling units, which was trained for 50 epochs. It reaches 62% accuracy at 20 epochs at ε=10.

Evaluate the heuristics with average case and worst case challenge points for models trained with and without differential privacy.

The results for CIFAR10 trained with DP and ε=10 for the average case, the density functions of the estimated \hat{ε} lower bound values for m=1, 10, 100, 1000 values coincide, with errors of 0 for m=10 and 0.001 for m=100 and m=1000, which validates the heuristic. For the worst-case, the CDF curves for m=10 and m=100 coincide to the baseline with an absolute error of 0.05 in both the cases. However, observe that using only a single model, i.e., m=1000 introduces a large error, which shows a decrease in performance on worst-case challenge points. Moreover, it is found that using worst-case challenge points gives tighter (higher) lower bound estimates of \hat{ε}.

The results for CIFAR10 without DP are now discussed. For these models, the goal is to measure the default empirical privacy guarantee offered by these models. It was found that for average case challenge points, the heuristic of m=10 introduces the smallest error of 0.31 with the error increasing 0.73 and 1.05 for m=100 and 1000 respectively. Moreover, it was found that the heuristic performs poorly on non-DP models using worst case challenge points. This is because the loss gap of the worst-case challenge points decreases as m grows, which negatively affects attack performance and yields lower empirical DP estimates for larger m. Hence, the sampling of multiple worst-case challenge points across the different heuristics cannot faithfully mimic the m=1 baseline. This is in contrast to models trained with DP, where worst-case challenge points do yield faithful estimates, see above.

In summary, the results show that, with average-case challenge points, the heuristic generally yields faithful estimates. For worst-case challenge points, the heuristic only performs well on models trained with DP-SGD. On models trained without DP, the heuristic significantly under-estimates the empirical DP bounds obtained from the m=1 baseline. This is because the loss gap of the worst-case challenge points decreases as m grows, which negatively affects attack performance and yields lower empirical DP estimates. Overall, the results show that the heuristic is able to yield faithful estimates.

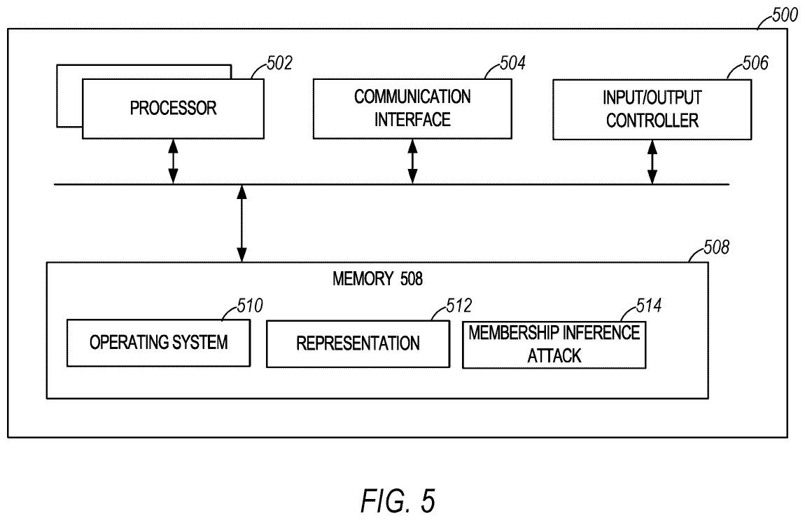

FIG. 5 illustrates various components of an exemplary computing-based device 500 which are implemented as any form of a computing and/or electronic device, and in which embodiments of a security measurement component are implemented in some examples.

Computing-based device 500 comprises one or more processors 502 which are microprocessors, controllers or any other suitable type of processors for processing computer executable instructions to control the operation of the device in order to measure a level of security of a training pipeline. In some examples, for example where a system on a chip architecture is used, the processors 502 include one or more fixed function blocks (also referred to as accelerators) which implement a part of the method of any of FIGS. 2, 3, 4 in hardware (rather than software or firmware). A representation 512 of a joint distribution over false positive rate and false negative rate is stored. Platform software comprising an operating system 510 or any other suitable platform software is provided at the computing-based device to enable application software to be executed on the device including an adversary which executes a membership inference attack 514.

The computer executable instructions are provided using any computer-readable media that are accessible by computing based device 500. Computer-readable media include, for example, computer storage media such as memory 508 and communications media. Computer storage media, such as memory 508, include volatile and non-volatile, removable and non-removable media implemented in any method or technology for storage of information such as computer readable instructions, data structures, program modules or the like. Computer storage media include, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Although the computer storage media (memory 508) are shown within the computing-based device 500 it will be appreciated that the storage is, in some examples, distributed or located remotely and accessed via a network or other communication link (e.g. using communication interface 504). Communication interface 504 is used to access a training pipeline such as that indicated in FIG. 1.

The computing-based device 500 also comprises an input/output controller 506 arranged to output display information to a display device which may be separate from or integral to the computing-based device 500. The display information may provide a graphical user interface to enable a user to input parameter values, view results of membership inference attacks, view counts of outcomes of membership inference attacks. The input/output controller 506 is also arranged to receive and process input from one or more devices, such as a user input device (e.g. a mouse, keyboard, camera, microphone or other sensor).

Alternatively or in addition to the other examples described herein, examples include any combination of the following:

A computer-implemented method of empirically measuring a level of security of a training pipeline, the training pipeline configured to train machine learning models using confidential training data, the method comprising:
storing a representation of a joint distribution of false positive rate and false negative rate of membership inference attacks on a plurality of machine learning models trained using the training pipeline;
using the representation to compute a posterior distribution of the level of security from observations of the membership inference attack on the plurality of machine learning models trained using the training pipeline;
computing a confidence interval of the level of security from the posterior distribution; and
storing the confidence interval.

Given an attack and a set of models, the FNR and FPR of the attack on that set of models are certain measurable quantities. The joint distribution is over a population of models trained using the pipeline.

The method described above wherein the representation of the joint distribution comprises a Bayesian model of the false positive rate and the false negative rate.

The method described in any of the above examples wherein the representation comprises a Dirichlet distribution.

The method described in any of the above examples wherein the representation of the joint distribution comprises, for each of the false positive rate and the false negative rate, a prior distribution which is a Beta distribution having parameters A and B, a count of observations of false positives or false negatives that is drawn from a Binomial distribution with parameters N (denoting the number of membership interference attacks observed) and a prior probability p drawn from the prior distribution, and a posterior distribution which is a Beta distribution with parameters A plus the count, and B plus N minus the count.

The method described above wherein A and B are both one half.

The method described above wherein A and B sum to one and are unequal so as to represent bias towards either the false positive rate or the false negative rate.

The method described above comprising computing a product of the posterior distribution of the false positive rate and the posterior distribution of the false negative rate.

The method described in any of the above examples wherein the observations are obtained by carrying out a membership inference attack on a plurality of machine learning models trained using the training pipeline and observing counts of false positives and false negatives of the membership inference attack.

The method described in the previous example comprising computing a posterior joint distribution of the false positive rate and the false negative rate from the representation and the counts of false positives and false negatives, wherein the posterior distribution of the level of security is computed from the posterior joint distribution of the false positive rate and the false negative rate.

The method described in the previous example wherein the posterior distribution of the level of security is represented as a cumulative distribution function computed by integrating the posterior joint distribution of the false positive rate and the false negative rate over a specified region. A cumulative distribution function is one of many ways of representing the posterior distribution.

The method described in any of the above examples wherein the level of security is a positive real value, where lower values of the value indicate higher security.

The method described in any of the above examples comprising comparing the confidence interval with a threshold and in response to the confidence interval being below the threshold deploying machine learning models trained using the training pipeline at unprotected devices.

The method described in any of the above examples comprising comparing the confidence interval with a threshold and in response to the comparison tuning hyperparameters of the training pipeline, the hyperparameters comprising one or more of: differential privacy parameters, number of training steps.

The method described in any of the above examples wherein the observations comprise more than one membership inference attack per machine learning model trained using the training.

The method described in any of the above examples wherein the training pipeline trains the machine learning model using a process with differential privacy.

The method described in any of the above examples wherein the training pipeline is configured to train convolutional neural networks to carry out object recognition tasks and wherein the training data set comprises images.

An apparatus for empirically measuring a level of security of a training pipeline, the training pipeline configured to train machine learning models using confidential training data, the apparatus comprising:
a memory storing a representation of a joint distribution of false positive rate and false negative rate of a membership inference attack on a plurality of machine learning models trained using the training pipeline;
instructions which when executed on a processor:
use the representation to compute a posterior distribution of the level of security from observations of the membership inference attack on the plurality of machine learning models trained using the training pipelines;
compute a confidence interval of the level of security from the posterior distribution; and
store the confidence interval.

The apparatus described in any of the above examples wherein the observations comprise more than one membership inference attack per machine learning model trained using the training pipeline and the training pipeline uses differential privacy.

The apparatus described in any of the above examples comprising the training pipeline deployed in a distributed manner on a plurality of computation nodes of a communications network.

The apparatus described in any of the above examples wherein the representation comprises, for each of the false positive rate and the false negative rate, a prior distribution which is a Beta distribution having parameters A and B, a count of observations of false positives or false negatives that is drawn from a Binomial distribution with parameters N (denoting the number of membership interference attacks observed) and a prior probability p drawn from the prior distribution, and a posterior distribution which is a Beta distribution with parameters A plus the count, and B plus N minus the count.

The apparatus described in any of the above examples wherein a membership inference attack occurs when an adversary, given the training pipeline, a distribution over the training data from which a training data set used by the training pipeline is drawn, and the number of training examples in the training data set, attempts to determine whether an example from the distribution belongs to the training data set used by the training pipeline.

A computerized system comprising:
one or more processors; and
computer storage memory having computer-executable instructions stored thereon which, when executed by the one or more processors, implement a method comprising:
storing a representation of a joint distribution of false positive rate and false negative rate of membership inference attacks on a plurality of machine learning models trained using the training pipeline;
using the representation to compute a posterior distribution of the level of security from observations of the membership inference attack on the plurality of machine learning models trained using the training pipeline;
computing a confidence interval of the level of security from the posterior distribution; and
using the confidence interval to tune hyperparameters of the training pipeline or to determine whether to deploy a machine learning model trained using the training pipeline outside a trusted execution environment.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that, by utilizing conventional techniques known to those skilled in the art, all or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A computer-implemented method of empirically measuring a level of security of a training pipeline, the training pipeline configured to train machine learning models using confidential training data, the method comprising:
storing a representation of a joint distribution of false positive rate and false negative rate of a membership inference attack on a plurality of machine learning models trained using the training pipeline;
using the representation to compute a posterior distribution of the level of security from observations of the membership inference attack on the plurality of machine learning models trained using the training pipeline;
computing a confidence interval of the level of security directly from the posterior distribution; and
storing the confidence interval.

2. The method of claim 1 wherein the representation of the joint distribution comprises a Bayesian model of the false positive rate and the false negative rate.

3. The method of claim 1 wherein the representation of the joint distribution comprises a Dirichlet distribution.

4. The method of claim 1 wherein the representation of the joint distribution comprises, for each of the false positive rate and the false negative rate, a prior distribution which is a Binomial distribution having parameters A and B, a count of observations of false positives or false negatives that is drawn from a Binary distribution with parameters N (denoting the number of membership interference attacks observed) and a prior probability p drawn from the prior distribution, and a posterior distribution which is a Beta distribution with parameters A plus the count, and B plus N minus the count.

5. The method of claim 4 wherein A and B are both one half.

6. The method of claim 4 wherein A and B are unequal so as to represent bias towards either the false positive rate or the false negative rate.

7. The method of claim 4, comprising computing a product of the posterior distribution of the false positive rate and the posterior distribution of the false negative rate.

8. The method of claim 7 wherein the observations are obtained by carrying out a membership inference attack on a plurality of machine learning models trained using the training pipeline and observing counts of false positives and false negatives of the membership inference attack.

9. The method of claim 8, comprising computing a posterior joint distribution of the false positive rate and the false negative rate from the representation and the counts of false positives and false negatives, wherein the posterior distribution of the level of security is computed from the posterior joint distribution of the false positive rate and the false negative rate.

10. The method of claim 9, wherein the posterior distribution of the level of security is represented as a cumulative distribution function computed by integrating the posterior joint distribution of the false positive rate and the false negative rate over a specified region.

11. The method of claim 10, comprising comparing the confidence interval with a threshold and in response to the confidence interval being below the threshold deploying machine learning models trained using the training pipeline at unprotected devices.

12. The method of claim 11, comprising comparing the confidence interval with a threshold and in response to the comparison tuning hyperparameters of the training pipeline, the hyperparameters comprising one or more of: differential privacy parameters, number of training steps.

13. The method of claim 12 wherein the membership inference attacks comprise more than one membership inference attack per machine learning model trained using the training pipeline.

14. The method of claim 13 wherein the training pipeline is configured to train convolutional neural networks to carry out object recognition tasks and wherein the training data set comprises images.

15. An apparatus for empirically measuring a level of security of a training pipeline, the training pipeline configured to train machine learning models using confidential training data, the apparatus comprising:
a memory storing a representation of a joint distribution of false positive rate and false negative rate of membership inference attacks on machine learning models trained using the training pipeline;
instructions which when executed on a processor:
use the representation to compute a posterior distribution of the level of security from observations of the membership inference attack on the plurality of machine learning models trained using the training pipeline;
compute a confidence interval of the level of security directly from the posterior distribution; and
store the confidence interval.
